(19) United States
(12) Patent Application Publication
(10) Pub. No.: US 2026/0243114 A1
(43) Pub. Date: Aug. 20, 2026

(54) VEHICLE DOOR LATCH AND ASSOCIATED VEHICLE DOOR MECHANISM

(71) Applicant: Minebea AccessSolutions France, Alfortville (FR)

(72) Inventors: François DEBROUCKE, Alfortville (FR); Jean-Marc VERBRUGGHE, Alfortville (FR); Corentin BOUTOILLE, Alfortville (FR)

(73) Assignee: Minebea AccessSolutions France, Alfortville (FR)

(21) Appl. No.: 19/533,413

(22) Filed: Feb. 9, 2026

(30) Foreign Application Priority Data
Feb. 19, 2025 (EP) 25315056

(51) Int. Cl. E05B 81/90; E05B 81/06; E05B 81/18; E05B 81/30; E05B 81/34

(52) U.S. Cl. CPC E05B 81/90; E05B 81/06; E05B 81/18; E05B 81/30; E05B 81/34

(57) ABSTRACT

A vehicle door latch for closing a vehicle door includes: a retention unit, an electrical release motor, an electrical gear wheel, and an opening lever that pivots around a rotation axis between a rest position and an opening position. The movement of the opening lever to the opening position moves the retention unit to its open position. The opening lever moves along the rotation axis between a first axial position engaging the electrical gear wheel and a second axial position disengaging from the electrical gear wheel such that the opening lever moves independently of the electrical gear wheel.

### TECHNICAL FIELD

The present invention relates to the field of vehicle door mechanism comprising latches to ensure the closing of vehicle doors. In particular, the invention relates to vehicle door latches comprising an electrical release mechanism.

### BACKGROUND OF THE INVENTION

Conventional door latches have a release system which is purely mechanical. End user directly activates a mechanical opening control that moves a cable which release a door latch of the door enabling the door to open. There are usually two mechanical opening controls on the door, an inside and an outside handle. In the event of a power failure, these two mechanical opening controls can still be used.

Nowadays, vehicles are more and more equipped with vehicle door latches comprising an electrical release mechanism, also called E-release mechanism which enables to open the door by a simple move such as a pressure on a switch or a movement in front of a detector. Such E-release mechanisms provide an additional comfort for the user.

A door latch generally comprises a retention unit configured for engaging with a striker on the vehicle body. In the process of electrically opening the latch, the retention unit, generally including a pawl that retains a claw, is driven by an electric motor in an open position allowing the pawl to free the claw. As soon as it is no longer retained by the pawl, the claw can pivot to release the striker.

When the latch is opened, it is necessary to then reset the door latch such that the pawl turns back to a rest position enabling the pawl to catch again the claw, if the door is closed.

However, in some instances, a safety procedure may occur to avoid the closure of the door, the reset being prevented after an electrical release. In other words, after the user has electrically opened the door latch by e-release, the door latch remains open, particularly the pawl of the retention unit remains in its open position and the door will not be able to be closed.

This can be planned to prevent the user from closing the door and no longer being able to open it again, for example to avoid the user from getting trapped in the vehicle. This might be the case in the event of a failure of an electric motor for instance or if the electrical power source is down or insufficient. An example might be after a crash. A backup energy of the door latch, with limited time availability, is then used allowing as last operation the electrical release with no reset to the rest position.

One aim of the present invention is to prevent at least partially the drawbacks of the prior art and to provide an electrical mechanism allowing to voluntarily reset the door latch, for instance in case of electric failure.

### SUMMARY OF THE INVENTION

The present invention refers to a vehicle door latch for closing a vehicle door, comprising: a retention unit configured for engaging with a striker in a closed position and releasing the striker in an open position, an electrical release motor, an electrical gear wheel configured to be driven by said motor, an opening lever configured to pivot around a rotation axis between a rest position and an opening position, the movement of the opening lever to the opening position being configured to move the retention unit to its open position.

According to the invention, the opening lever is configured to move along the rotation axis between:
a first axial position in which the opening lever engages the electrical gear wheel allowing the electrical gear wheel to drive the opening lever, and
a second axial position in which the opening lever disengages from the electrical gear wheel such that the opening lever is configured to move independently of the electrical gear wheel.

The vehicle door latch may further include one or more of the following features taken alone or in combination.

The opening lever may comprise a pushing zone.

The opening lever may be configured to move to the second axial position when a resetting device configured to be manipulated from the outside of the door latch reaches the pushing zone of the opening lever and displaces the opening lever.

The vehicle door latch may include a member of the resetting device, mounted in a housing of said door latch, mobile in translation along a translation axis parallel to the rotation axis.

Said member may comprise an end part protruding outside a face of the housing intended to be accessible from the outside of said door latch.

The vehicle door latch may comprise a housing with a face intended to be accessible from the outside of said door latch, said face being provided with an aperture facing said pushing zone, and through which a member of the resetting device external to said door latch may be configured to be inserted.

The face of the housing intended to be accessible from the outside of said door latch may be intended to be placed in front of the striker and may comprise a guide slot in which the striker is arranged.

The vehicle door latch may comprise a spring arranged to bring the opening lever back in the rest position.

The vehicle door latch may comprise a spring arranged to bring the opening lever back in the first axial position.

In the first axial position, a leg of the opening lever may be received in a corresponding slot defined in the electrical gear wheel.

Iin the second axial position, the leg of the central opening lever may be out of the corresponding slot defined in the electrical gear wheel.

The spring may be arranged to bring the opening lever back in the first axial position, when the slot defined in the electrical gear wheel faces the leg of the opening lever.

The vehicle door latch may further comprise a mechanical release mechanism.

The mechanical release mechanism may comprise an inner release lever configured to move independently of the electrical gear wheel and configured to move the retention unit from the closed position to the open position.

The inner release lever may be configured to drive the opening lever from the rest position to the opening position for moving the retention unit.

The mechanical release mechanism may comprise an outer release lever configured to move independently of the electrical gear wheel and configured to move the retention unit from the closed position to the open position.

The vehicle door latch may comprise an intermediate opening lever, for instance of a driver of said door latch, the intermediate opening lever being configured to move the pawl in the open position.

The electrical gear wheel may be configured to be driven by said motor, between a rest position and an opening position, the opening lever being configured to be driven in the opening position by the movement of the electrical gear wheel to its opening position.

In case of an electrical failure, the electrical release motor may be configured to block the electrical gear wheel in a position preventing the opening lever from returning to the rest position.

Said motor may be configured to block the electrical gear wheel in an opening position or in an intermediate position between the rest position and the opening position.

When displaced in the second axial position, the opening lever disengaged from the electrical gear wheel, may be configured to return to the rest position allowing the retention unit to return to the closed position.

When the opening lever is in the rest position while disengaged from the electrical gear wheel, only the mechanical release mechanism may be configured to move the retention unit from the closed position to the open position.

After the opening lever is moved to its opening position driven by the inner release lever, if the leg of the opening lever in the opening position faces the slot defined in the electrical gear wheel, the spring may be configured to bring the opening lever back in the first axial position, such that the movement of the opening lever is blocked by the electrical gear wheel.

When the electrical failure is overcome, the electrical release motor may be configured to bring the electrical gear wheel back in a rest position.

When the slot defined in the electrical gear wheel faces the leg of the opening lever in the rest position, the spring may be configured to bring the opening lever back in the first axial position.

The retention unit may comprise a claw and a pawl, configured to move, at least between an open position and a closed position. The pawl may be subjected to an elastic return force which pushes it in the closed position toward the claw.

A worm may be arranged on an output shaft of the electrical release motor. The electrical gear wheel may be configured to mesh with the worm to be rotated between the rest position and the opening position.

The opening lever, the electrical gear wheel and the inner release lever may be coaxial.

The invention also relates to a vehicle door mechanism including a vehicle door latch as defined above, for closing a vehicle door, said door latch comprising: a retention unit configured for engaging with a striker in a closed position and releasing the striker in an open position, an electrical release motor, an electrical gear wheel configured to be driven by said motor, an opening lever configured to pivot around a rotation axis between a rest position and an opening position, the movement of the opening lever to the opening position being configured to move the retention unit to its open position.

The opening lever is configured to move along the rotation axis between:
a first axial position in which the opening lever engages the electrical gear wheel allowing the electrical gear wheel to drive the opening lever, and
a second axial position in which the opening lever (9) disengages from the electrical gear wheel (5) in which the opening lever (9) is configured to move independently of the electrical gear wheel.

The vehicle door mechanism further comprises a resetting device configured to be manipulated from the outside of the door latch, and when manipulated, a member of the resetting device is configured to reach the opening lever and to displace the opening lever to the second axial position disengaged from the electrical gear wheel.

When manipulated, the member of the resetting device may be configured to translate along a translation axis parallel to the rotation axis.

According to an embodiment, the resetting device may be external to said door latch.

Said member may be configured to be inserted inside the door latch through the aperture in the face of the housing of said door latch, intended to be accessible from the outside of said door latch, the aperture facing the pushing zone of the opening lever.

According to another embodiment, said door latch may comprise the resetting device.

The vehicle door latch and the vehicle door mechanism as defined above allow the user to voluntarily reengage the retention unit in the rest position, by pushing on the opening lever, thus allowing manually closing the door, for instance in case of an electrical failure. Potentially the main battery may be replaced later to allow again electrical releasing.

### BRIEF DESCRIPTION OF THE DRAWINGS

FIG. 1 is an exploded view of an embodiment of a vehicle door mechanism comprising a vehicle door latch for closing the door and a manual tool configured to cooperate with the door latch.

FIG. 2 is a perspective view of the vehicle door mechanism with the manual tool cooperating with the vehicle door latch mounted in a housing.

FIG. 3 shows parts of the vehicle door latch in a rest position of a central opening lever and an electrical gear wheel of an electrical release mechanism.

FIG. 4a shows parts of the vehicle door latch with the central opening lever driven by an inner release lever according to a first embodiment of a mechanical release mechanism.

FIG. 4b shows parts of the vehicle door latch with the central opening lever driven by an inner release lever according to a second embodiment of a mechanical release mechanism.

FIG. 5 is a cross view of the vehicle door mechanism of FIG. 1 and FIG. 2 with the manual tool inserted inside the door latch for pushing the central opening lever.

FIG. 6 is a cross view of an alternative of the vehicle door latch including a pin that can be manually handled for pushing the central opening lever.

FIG. 7 shows parts of the vehicle door latch in an opening position, after pushing out the central opening lever to disengage from the electrical gear wheel.

FIG. 8 shows parts of the vehicle door latch with the opening lever disengaged from the electrical gear wheel turned back in the rest position while the electrical gear wheel is blocked in the opening position.

FIG. 9 shows parts of the vehicle door latch with the electrical gear wheel blocked in an intermediate position while the opening lever is disengaged from the electrical gear wheel.

FIG. 10 shows parts of the vehicle door latch of FIG. 9 with the opening lever disengaged from the electrical gear wheel turned back in the rest position while the electrical gear wheel is blocked in the intermediate position.

In these figures, the identical elements have the same reference numbers. Only the elements necessary for the understanding of the invention are shown.

### DETAILED DESCRIPTION OF THE INVENTION

The following embodiments are examples. Although, the specification refers to one or several embodiments, it does not imply that each reference refers to the same embodiment or that the features apply only to a single embodiment. Simple features of different embodiments can also be combined to provide other embodiments, without departing from the scope of the invention, as defined by the claims.

In the description, some elements may be indexed, for example first element or second element. In this case, it is a simple indexing to differentiate and name similar but not identical elements. This indexing does not imply a priority of one element over another and such names can easily be interchanged without going beyond the scope of the present invention.

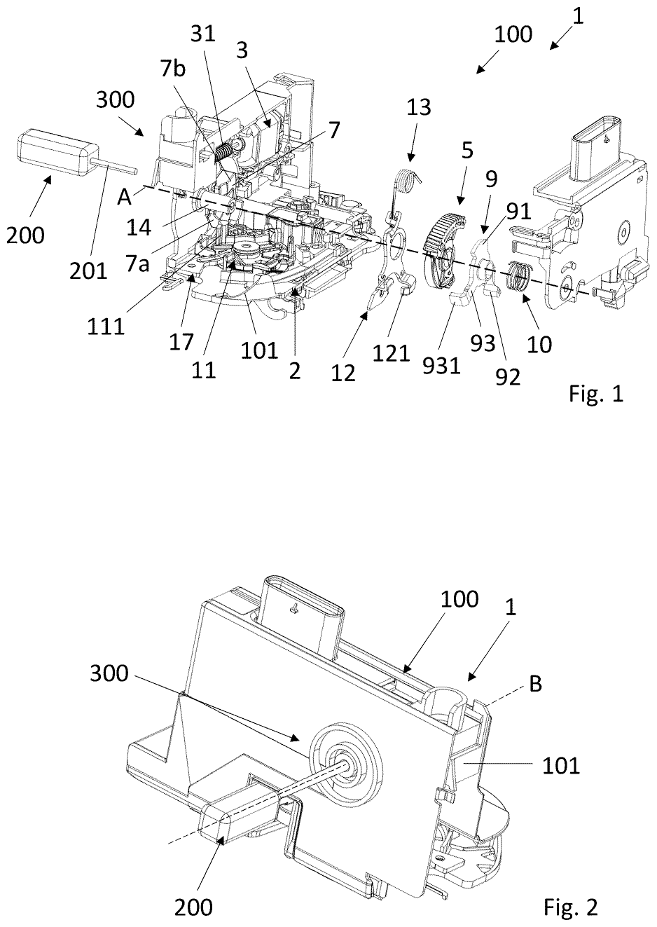

Referring to FIG. 1 and FIG. 2, the present invention refers to a vehicle door mechanism 1 comprising a vehicle door latch 100 and a resetting device 200. The door latch 100 is configured to ensure the closing of a door of a vehicle, particularly of a motor vehicle. The resetting device 200 allows a user to voluntarily reset the door latch 100 in a rest position, if the reset has been prevented for example after an electrical release of the door latch 100, as a safety procedure, for instance in case of an electrical failure.

In the following, the term “door” is used in its widest sense to indicate any member movable between an open and a closed position to open and close an access opening to an internal compartment of a vehicle, and therefore includes hoods and rear doors, trunks, or front trunks, also known as “frunks”, in addition to the vehicle side doors.

### Vehicle Door Latch

### Retention Unit

The door latch 100 comprises a retention unit 2 that may include a claw and a pawl (not visible in the figures). The retention unit 2 is arranged at least partially inside a housing 101 of the door latch 100 and is covert by the housing 101 in the figures.

The claw and the pawl are both configured to move, in particular pivot, at least between an open position and a closed position.

The pawl may possibly be subjected to an elastic return force which pushes it toward the claw. The claw may be subjected to an elastic return force which pushes it in the open position.

In the closed position, the retention unit 2 can engage with a striker (not represented) of the vehicle. The striker may be trapped in the claw while the pawl prevents the rotation of the claw. For instance, the pawl may abut against a catching surface of the claw. The striker is intended to be arranged on the vehicle body next to the vehicle door and is configured to be introduced into a recess of the door latch 100 when the vehicle door is closed.

In the open position, the retention unit 2 can release the striker to release the door latch 100. The pawl may allow the rotation of the claw, and the rotation of the claw releases the striker so the door can be opened.

According to an embodiment, the retention unit 2 may comprise a driver (not visible) configured to rotate around a rotation axis and to engage with the pawl to rotate the pawl between its closed position and its open position.

### Electrical Release Mechanism

The vehicle door latch 100 comprises an electrical release motor 3 and an electrical gear wheel 5 that is configured to be moved by the electrical release motor 3, thus electrically, from an initial or rest position to an opening position. The electrical release motor 3 and the electrical gear wheel 5 may be parts of an electrical release (E-release) mechanism of the door latch 100.

The electrical release motor 3 may be activated by a control unit of the door latch 100 when a user activates an electrical (or electronical) opening control, such as a switch of a door or a key, or a movement in front of a detector.

More precisely, the electrical release motor 3 has an output shaft 31 configured to rotate the electrical gear wheel 5. The gear wheel 5 may be configured to rotate around a rotation axis A. In the following, the terms “axial”, “axially”, “radial”, “radially” are defined regarding the rotation axis A.

The electrical gear wheel 5 may be configured to mesh with a worm or endless screw arranged on the output shaft 31 of the electrical release motor 3. The electrical gear wheel 5 may comprise teeth only on a portion of circle which depends on the angular difference between the rest position and the opening position of the electrical gear wheel 5.

The electrical release mechanism may also comprise a stop 7 having a general shape of a portion of a disc.

The electrical gear wheel 5 may be configured to come into contact with a first side 7a of the stop 7 in the rest position and with a second side 7b of the stop 7 in the opening position.

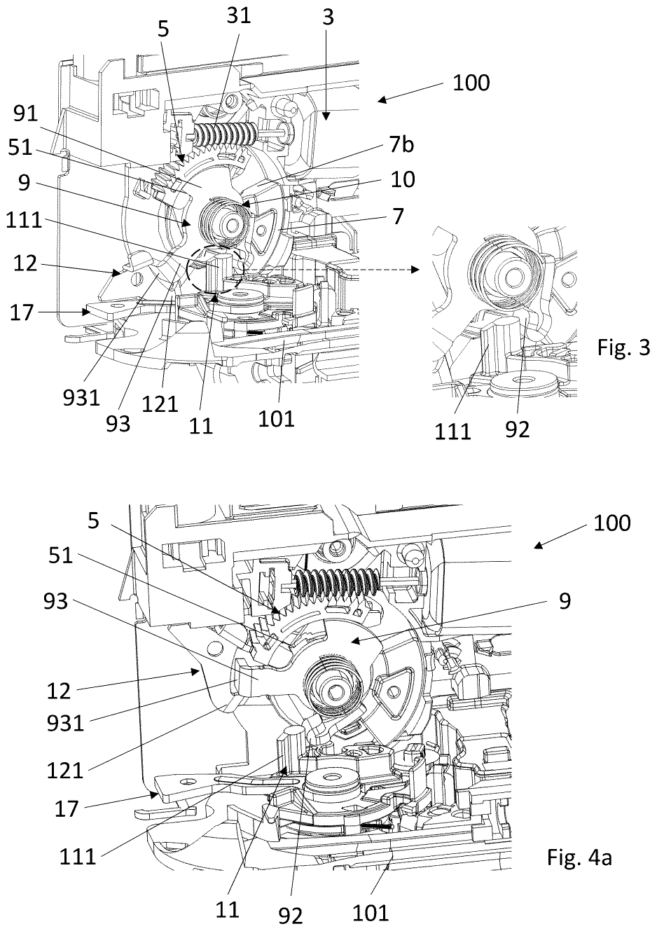

The rotation of the electrical gear wheel 5 may be configured to move an opening lever 9 of the door latch 100, to a position leading to the release of the door latch 100, as explained afterwards. For this purpose, an axial protrusion 51 (visible in FIG. 3) of the electrical gear wheel 5 may be configured to interact with the opening lever 9.

The electrical release motor 3 may be configured to bring the gear wheel 5 back in its rest position after the retention unit 2 is released. According to an embodiment, the electrical release motor 3 may be a reversible motor (the output shaft 31 can be rotated in a clockwise or a counterclockwise direction). Thus, after the electrical releasing of the door, the control unit of the door latch 100 may control the electrical release motor 3 to rotate the electrical gear wheel 5 in the opposite direction, back in the rest position.

In some circumstances, for instance in the event of an electric failure, the door latch 100 may be configured to prevent a reset, namely, to prevent the retention unit 2, particularly the pawl, from turning back to its closed position. For this purpose, the gear wheel 5 may be blocked by the electrical release motor 3, more precisely by the output shaft 31, in position, for instance in the opening position or in an intermediate position.

### Opening Lever

The opening lever 9 of the door latch 100, also called hereafter central opening lever 9, can move between a rest position and an opening position.

The central opening lever 9 may be subjected to an elastic return force which pushes it in the rest position. For example, an elastic part, such as a spring 10 may be arranged to bring the central opening lever 9 back in its rest position. The spring 10 may be arranged around a central protrusion of the central opening lever 9, said central protrusion may protrude axially.

The central opening lever 9 may be a pivoting lever configured to rotate around a rotation axis. According to an embodiment, the electrical gear wheel 5 and the central opening lever 9 are coaxial. Therefore, the central opening lever 9 may rotate around the rotation axis A.

According to an embodiment, the central opening lever 9 may comprise one or more legs 91, 92, 93 extending radially. For example, the central opening lever 9 comprises a first leg 91, a second leg 92, and a third leg 93. The first leg 91 may have a circular arc shape.

In operation, the central opening lever 9 may be driven to its opening position by the electrical gear wheel 5.

The central opening lever 9 is arranged in a manner such that it can engage or disengage with the electrical gear wheel 5. More precisely, the central opening lever 9 may be configured to be displaced between a first axial position and a second axial position relative to the electrical gear wheel 5.

### First Axial Position

In the first axial position, the central opening lever 9 may be in contact with and may engage with the electrical gear wheel 5 such that they can turn together. Particularly, the first leg 91 of the central opening lever 9 may be received in a corresponding slot defined in the electrical gear wheel 5.

Therefore, in case of an electrical release of the door latch 100, a user activates an electrical opening control, which activates the electrical release motor 3. The rotation of the output shaft 31 of the electrical release motor 3 moves the electrical gear wheel 5 in rotation. This rotation engages the central opening lever 9 to rotate it to the opening position.

Referring to FIG. 3, the axial protrusion 51 of the electrical gear wheel 5 may protrude axially such that a part of the central opening lever 9, particularly an end of the first leg 91, is on the path of the axial protrusion 51 of the electrical gear wheel 5 in the direction of movement of the electrical gear wheel 5 to the opening position. The axial protrusion 51 may delimit the slot receiving the first leg 91. Thus, the electrical gear wheel 5 and the central opening lever 9 turn together when the electrical gear wheel 5 is driven to the opening position.

As an alternative not shown, the central opening lever 9 may have an axial protrusion protruding axially towards the electrical gear wheel 5 to be on the path of the electrical gear wheel 5 in the direction of movement of the electrical gear wheel 5 to the opening position.

In the event of an electrical failure and/or during a safety procedure, the central opening lever 9 may be blocked by the electrical gear wheel 5 in position such as its opening position or an intermediate position, in particular against the return force of the spring 10, so that the central opening lever 9 cannot turn back to its rest position.

### Second Axial Position

In the second axial position, the central opening lever 9 is distanced axially from the electrical gear wheel 5, such that the central opening lever 9 can disengage from the electrical gear wheel 5. A gap is thus formed between the central opening lever 9 and the electrical gear wheel 5, so that one can rotate without interacting with the other one.

Particularly, in the second axial position, the first leg 91 of the central opening lever 9 is no more received in the corresponding slot defined in the electrical gear wheel 5, it is out of it.

For example, the central opening lever 9, particularly the first leg 91, does not abut against the electrical gear wheel 5, particularly the axial protrusion 51. In other words, the first leg 91 is not and cannot be on the path of the electrical gear wheel 5 in the direction of movement of the electrical gear wheel 5 to the opening position. If the central opening lever 9 rotates, the electrical gear wheel 5 remains therefore in its current position.

The elastic part, such as the spring 10 may bring the central opening lever 9, disengaged from the electrical gear wheel 5, back in its rest position, even in the case the electrical gear wheel 5 is blocked in the opening position.

The elastic part, such as the spring 10 may further be configured to bring the central opening lever 9 back in the first axial position. When the first leg 91 of the central opening lever 9 faces the slot in the electrical gear wheel 5, the central opening lever 9 may be pushed back by the spring 10, to engage with the electrical gear wheel 5.

### Rotation

Besides, the movement (rotation) of the central opening lever 9 towards its opening position may lead to open/release the door latch 100.

More precisely, the movement of the central opening lever 9 from the rest position to its opening position can move an intermediate opening lever 11 of the door latch 100 (particularly of the driver of the door latch 1) which is configured to move the pawl in the open position to disengage from the claw and then release the door latch 100.

The central opening lever 9 may be configured to push a protruding element 111 of the intermediate opening lever 11, for example through a tab or leg. In the described embodiment, the end of the second leg 92 of the central opening lever 9 may be configured to push such a protruding element of the intermediate opening lever 11.

The intermediate opening lever 11, that may be a pivoting lever, is configured to move between a rest position and an opening position. The intermediate opening lever 11 may be subjected to an elastic return force, such as a spring (not shown), which pushes it in rest position.

### Mechanical Release Mechanism

The door latch 100 may also comprise an inner release lever 12 configured to move between a rest position and a release position. The inner release lever 12 may be part of a mechanical release mechanism.

The inner release lever 12 may be moved by an inner mechanical opening control of the vehicle door, such as an inside handle, from the inside of the vehicle. For that purpose, the inner release lever 12 may be mechanically linked to the inner mechanical opening control, such as the inside handle, for example by a cable or by a rod. This cable/rod can be pulled by a user activating the inner mechanical opening control as the inside handle.

The inner release lever 12 may be subjected to an elastic return force which pushes it in the rest position. A return spring 13 may be arranged to bring the inner release lever 12 back in the rest position when a user releases the mechanical opening control or handle linked to the inner release lever 12. The return spring 13 may be arranged between the inner release lever 12 and the housing 101 of the vehicle door latch 100 or a part which is fixed relative to the housing 101.

The inner release lever 12 may be a pivoting lever configured to rotate around a rotation axis, that may coincide with the rotation axis A.

The inner release lever 12 is arranged in a way such that it can move, rotate independently of the electrical gear wheel 5.

The gear wheel 5 is for example arranged between/axially interposed between the inner release lever 12 and the central opening lever 9 along a common shaft 14. The shaft 14 may extend longitudinally along the rotation axis A. The gear wheel 5, the inner release lever 12 and the central opening lever 9 may be pivotally mounted on the common shaft 14. The gear wheel 5, the inner release lever 12 and the central opening lever 9 are therefore arranged in a coaxial manner.

In operation, the central opening lever 9 may be driven to the opening position by the movement of the inner release lever 12.

For this purpose, the inner release lever 12 may comprise an axial protrusion 121 configured to come in contact with the central opening lever 9. As an alternative or in combination, the central opening lever 9 may comprise an axial protrusion 931, for instance at the end of one leg 93, configured to come in contact with the inner release lever 12.

The axial protrusion 931 of the central opening lever 9 may protrude axially to be on the path of the axial protrusion 121 the inner release lever 12 in the direction of movement of the inner release lever 12 to the opening position. Thus, the inner release lever 12 and the central opening lever 9 turn together when the inner release lever 12 is driven to the opening position.

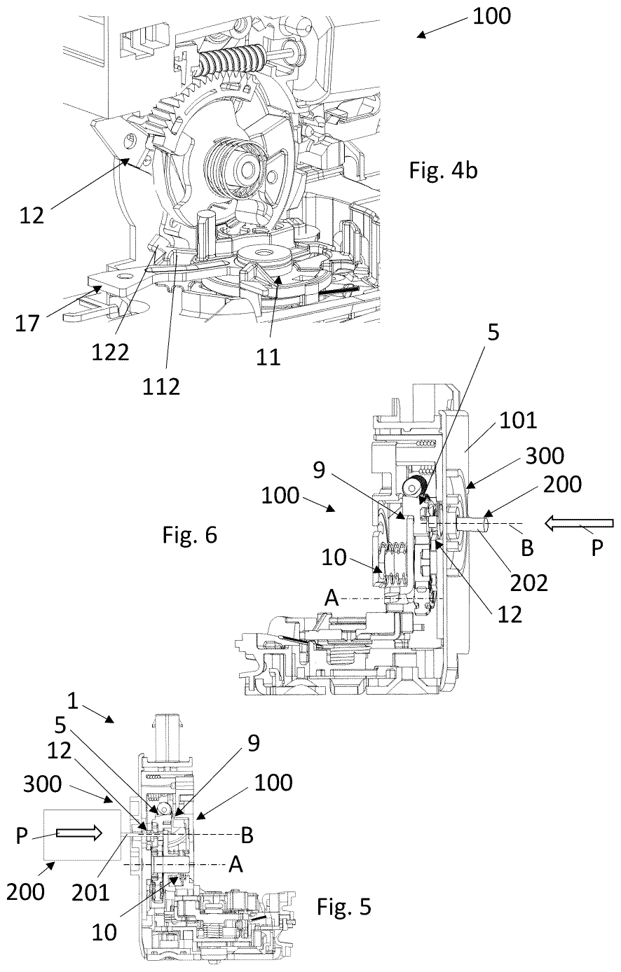

Thus, as can be seen FIG. 4a, during an inner opening mechanical release, the inner release lever 12 is moved in rotation by a user activating the inside handle from inside the vehicle. The rotation of the inner release lever 12 drives the central opening lever 9 in rotation to its opening position, which in turn moves the intermediate opening lever 11 in rotation, which moves the pawl to disengage it from the claw, thus releasing the door latch 100.

When the central opening lever 9 is driven to its opening position by the inner release lever 12, the electrical gear wheel 5 is not driven in motion. However, during an electrical release, the inner release lever 12 is not moved. Indeed, the inner release lever 12 is disengaged from the central opening lever 9 when the central opening lever 9 is driven in rotation by the electrical gear wheel 5 from its rest position to its opening position.

After the inner opening mechanical releasing of the door, when the user releases the inside handle, the inner release lever 12 may rotate back to the rest position.

Referring to FIG. 4b, according to another embodiment of the inner release lever 12, the latter may be configured to interact directly with the intermediate opening lever 11, without the intermediary of the central opening lever 9, without moving it.

To this end, the inner release lever 12 may comprise a lug 122 configured to come in contact with the intermediate opening lever 11. As an alternative or in combination, the intermediate opening lever 11 may comprise a protrusion 112 configured to come in contact with the inner release lever 12.

The protrusion 112 of the intermediate opening lever 11 may protrude axially to be on the path of the lug 122 of the inner release lever 12 in the direction of movement of the inner release lever 12 to the opening position. Thus, when the inner release lever 12 is driven to the opening position, it moves the intermediate opening lever 11 in rotation.

Besides, the door latch 100 may comprise an outer release lever 17 that can be moved by an outer mechanical opening control of the vehicle door, such as an outside handle, from the outside of the vehicle, from a rest position to a release position. The outer release lever 17 is mechanically linked to the outer mechanical opening control for example by a cable that can be pulled by the user activating the outer mechanical opening control or outside handle.

The outer release lever 17 may be a pivoting lever. The outer release lever 17 may be subjected to an elastic return force which pushes it in the rest position.

For example, in an unlocked position of the door latch 100, the movement of the outer release lever 17 may possibly move a lever of the driver, such as a pivoting lever, that can move the intermediate opening lever 11. Such a lever may be subjected to an elastic return force which pushes it in rest position.

The outer release lever 17 may be part of the mechanical release mechanism.

### Resetting Device

As previously stated, the vehicle door mechanism 1 also comprises the resetting device 200 for manually resetting the door latch 100, for instance if the automatic reset has been prevented due to an electrical failure and/or a safety procedure.

### Electrical Failure

An electrical failure may occur if the electrical release motor 3 has a failure or if the power supply is insufficient. This can happen when the door is closed, or during or after a complete electrical release.

If the door is closed, the electrical gear wheel 5 and the central opening lever 9 are in the rest position. If the electrical failure occurs after a complete electrical release, at the end of travel of the electrical gear wheel 5 and the central opening lever 9, they may be blocked in the opening position by the electrical release motor 3. If the electrical failure occurs during an electrical release, the electrical gear wheel 5 and the central opening lever 9 may be blocked in an intermediate position, in between the rest and opening positions.

The vehicle door mechanism 1, more precisely the door latch 100, may have a safety function or safety procedure, for instance in case of such an electrical failure. The safety procedure is provided for preventing the user from being locked inside the vehicle.

If a safety procedure is initiated, the electrical gear wheel 5 may be blocked in the opening position after an electrical release.

If the door latch 100 is closed, the retention unit 2 is in the closed position, the central opening lever 9 is in its rest position. When a safety procedure is initiated, the last possible electrical operation is to initiate an electrical release of the door latch 100, for example by the activation of the electrical opening control. The electrical release motor 3 thus drives the electrical gear wheel 5 towards its opening position which drives the central opening lever 9 to its opening position and then to the release of the retention unit 2 as explained above.

If the door latch 100 is open, the retention unit 2, particularly the pawl, is in the open position. When a safety procedure is initiated, the electrical gear wheel 5 remains in the opening position, being blocked by the electrical release motor 3, and thus blocking in turn the central opening lever 9 in its opening position, if they are both engaged (first axial position). The retention unit 2 is blocked in its open position.

### Manual Resetting

Referring again to FIG. 1 and FIG. 2, the resetting device 200 is configured to reset the door latch 100. This can be done when the central opening lever 9 is blocked, for instance in the event of an electrical failure and/or a safety procedure.

The user can manually manipulate the resetting device 200 from the outside of the door latch 100, to disengage the electrical gear wheel 5 and the central opening lever 9. The resetting can be done when the door is opened or closed. There are no restrictions on whether the door is open or closed.

The housing 101 of the door latch 100 may be arranged behind a casing 300 protecting the mechanisms inside the door latch 100. The casing 300 may be located at least on a side or face of the door latch 100, that is intended to be accessible from the outside of the door latch 100, for instance next to the user seat in the vehicle. This permits the user a direct access without requiring any additional machining. It can be accessed from the inside of the vehicle. It is for example in the vicinity of an area or a guide slot also called “fish mouth” configured to receive the striker.

A cap or a flap may possibly be arranged as a protection in front of the casing 300. For a manual resetting operation, the user can easily remove the cap or flap.

The resetting device 200 is configured to displace the central opening lever 9:
from the first axial position engaging with the electrical gear wheel 5, wherein the rotation of the latter drives the moving of the central opening lever 9,
to the second axial position disengaging the electrical gear wheel 5, such that the movement of the central opening lever 9 is not lead by a rotation of electrical gear wheel 5, nor blocked by the electrical gear wheel 5.

The resetting device 200 may be intended to cooperate with a pushing zone on the central opening lever 9. For instance, the pushing zone may be defined on the first leg 91. Such a pushing zone is an internal zone of the door latch 100.

The resetting device 200 may include at least a member 201 or 202 (FIG. 5, FIG. 6). Preferably, the member 201 or 202 extends longitudinally.

The resetting device 200 may be moved in translation along a translation axis B parallel to the rotation axis A of the central opening lever 9 to reach and cooperate with the latter. The user may manipulate the resetting device 200, such that the member 201, 202, particularly an end of the member 201, 202 can reach the pushing zone of the central opening lever 9. Through the member 201 or 202, the user may push the pushing zone of the central opening lever 9. The translation of the member 201 or 202 over the full stroke pushes the central opening lever 9 from the first axial position to the second axial position.

According to a first example, the resetting device 200 may be external to the door latch 100 (FIG. 5). It may be a manual tool, for example a dedicated tool as represented in FIG. 5 or any existing tool as a key, a screwdriver.

The member 201 of the resetting device 200 can enter inside the door latch 100 through the casing 300. Thus, the casing 300 may comprise an aperture placed in front of the pushing zone of the central opening lever 9.

This aperture in the casing 300 may be aligned with an aperture in the housing 101. These apertures may also be aligned with apertures in the electrical gear wheel 5 and/or the inner release lever 12, or with an empty internal area of the door latch 100, such that the electrical gear wheel 5 and/or the inner release lever 12 is not in the path of the member 201 when inserted.

The user may introduce the member 201 through the aperture in the casing 300 and/or in the housing 101. The user may manually operate the tool for entering it, through the aperture, inside the door latch 100 to reach the central opening lever 9, namely its pushing zone. The user may then push the central opening lever 9 as illustrated by the arrow P. The axis for pushing coincides with the translation axis B.

For this purpose, the member 201 may be formed by an arm, a shaft or axis long enough to pass over or through the inner release lever 12 and the electrical gear wheel 5, to reach the central opening lever 9 and then allowing to further push the central opening lever 9.

For the user's comfort, a handle may be provided at the end of the member 201 for the user to hold and manipulate.

According to a second example, the resetting device 200 may comprise a member 202 embedded with the door latch 100 (FIG. 6) and not external to the door latch 100. This may include, but is not limited to, a pin, a rod, a spindle, a lever, an arm, a shaft, an interface like a small button which is integrated on the door latch 100. This alternative embedded with the door latch 100 does not require any additional or external tool for the resetting operation.

Such a member 202 is mounted movable in translation along the translation axis B. It can be maintained in the housing 101. The door latch 100 may be provided with a translation guide for the member 202. The member 202 is designed to be movable over a distance that enables it to cooperate with, to push, the central opening lever 9.

Further, the member 202 is mounted in the housing 101 of the door latch 100 so that an end part of it protrudes along the translation axis B outside the housing 101, to be accessible for the user. If a casing 300 is assembled with the housing 101, the protruding part of the member 202 protrudes out of the casing 300. The protruding part of the member 202 may be covered by the cap or flap to be removed by the user. When needed, the user may press or push on the protruding part of the member 202 as illustrated by the arrow P along an axis coinciding with the translation axis B.

The remaining part of the member 202 inside the door latch 100 is long enough, to pass over or through the inner release lever 12 and the electrical gear wheel 5, to reach and push the central opening lever 9.

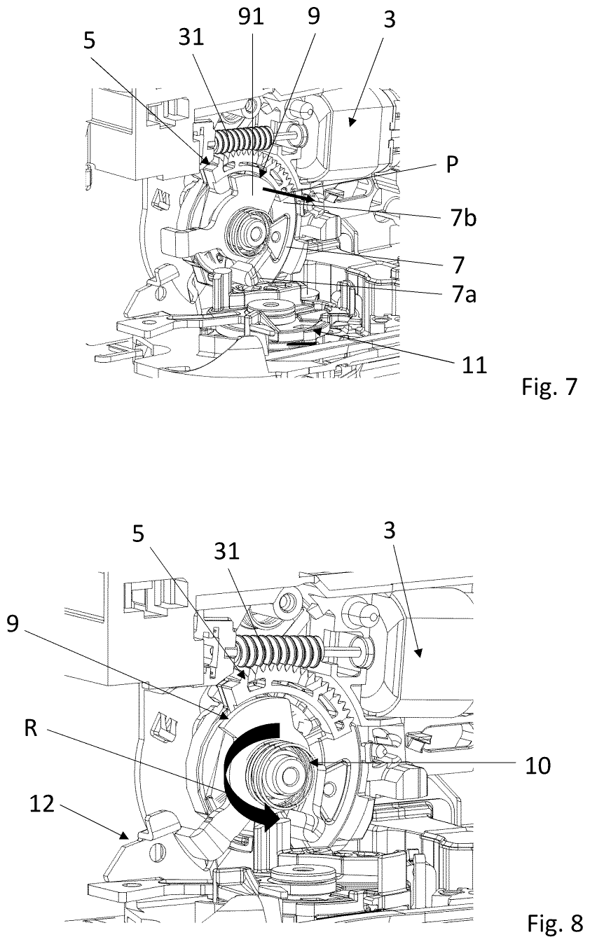

Regardless the embodiment of the resetting device 200, when it pushes out (arrow P) the central opening lever 9, the latter is displaced in the second axial position and is disengaged from the electrical gear wheel 5, as illustrated in FIG. 7.

Due to the disengagement of the central opening lever 9 from the electrical gear wheel 5, the central opening lever 9 is free to move (rotate) and can be brought back, for instance by the spring 10, in its rest position (arrow R), as illustrated in FIG. 8. On the contrary, the electrical gear wheel 5 does not pivot around the rotation axis A and stays in place in its current position, such as the opening position being blocked by the output shaft 31.

After reset, the door latch 100 can be operated in a backup mode, allowing manual closing or opening the door. The door latch 100 thus becomes a purely mechanical latch, at least until the electrical failure is overcome (electrical power is back or the E-release function is working again). In other words, when the opening lever 9 is back in the rest position while disengaged from the electrical gear wheel 5, only the mechanical release mechanism may move the retention unit 2 between the closed position and the open position.

More precisely, with the central opening lever 9 brought back in its rest position, the intermediate opening lever 11 may also return to its rest position, for instance due to a return force of a spring. Hence, the pawl may return to the closed position wherein it can catch again the claw when the door is closed. The retention unit 2 is then able to engage with the striker. It is then possible to close the door safely.

If the door must be opened, the opening position can be led by the mechanical release mechanism, as described above.

According to the first embodiment of the central opening lever 9 and the inner release lever 12, after reset, the central opening lever 9 is still in contact with the intermediate opening lever 11. During an inner opening mechanical release, the central opening lever 9, disengaged from the electrical gear wheel 5, is driven in rotation by the inner release lever 12 from its rest position to its opening position (cf. FIG. 4a), which in turn moves the intermediate opening lever 11 configured to move the pawl in the open position to release the door latch 100.

In other words, when resetting and activating the manual release, the electrical release kinematics is overpassed. However, the central opening lever 9 lever is still in link with the intermediate opening lever 11 to ensure it will not disengage. This ensures the release is still possible.

If the safety procedure is still on/as the electrical failure has not been overcome, after the mechanical release, the central opening lever 9 in the opening position will engage again with the electrical gear wheel 5 still blocked in the opening position. In that position, the first leg 91 is placed in front of the corresponding slot in the electrical gear wheel 5, and the spring 10 pushes down (pushes back) the central opening lever 9 in the first axial position wherein it engages again with the electrical gear wheel 5. The central opening lever 9 is thus blocked again in the opening position.

Therefore, each time the door is manually opened, the door latch 100 is blocked in the open position. The user will have to voluntary reset the door latch 100 by pushing again the central opening lever 9 out. The e-release kinematic is still blocked in the open position as long as the safety procedure is on, if the electrical failure is not overcome, there is no electrical power back.

The resetting operation is also compatible if the inner opening mechanical release is according to the second embodiment (FIG. 4b).

Similarly to the first embodiment, when the central opening lever 9 is back in its rest position, the intermediate opening lever 11 is reset and the pawl may return to the closed position wherein it can catch again the claw.

The door latch 100 can then be operated in a manual backup mode, except that the central opening lever 9 is not driven in rotation by the inner release lever 12 nor in contact with the intermediate opening lever 11. On the contrary, the inner release lever 12 directly moves the intermediate opening lever 11 configured to move the pawl in the open position to release the door latch 100.

The door can also be opened from outside, when the outer mechanical opening control of the vehicle door, such as an outside handle, is pulled by a user. The movement of the outer release lever 17 may possibly move a lever of the driver, that can move the intermediate opening lever 11, and then the pawl.

The user can manually reset the door latch 100 when the door latch 100 is blocked in the open position after an electrical release, for instance if a safety procedure has occurred.

But the door latch 100, and particularly the central opening lever 9 can be in several positions, other than blocked in the opening position, when a user engages the manual reset.

For example, the user may push the central opening lever 9, when the door latch 100 is in the closed position. This will not affect the door latch 100. This way the central opening lever 9 is already in its rest position (FIG. 3), such that the claw can catch the pawl when the door is closed. At first electrical release operation, if the safety procedure is initiated, the central opening lever 9 will be blocked by the electrical gear wheel 5, unless the user pushes out the opening lever 9. As previously described, the door latch 100 can then operate as a mechanical latch, in said backup mode, at least until the electrical failure is overcome.

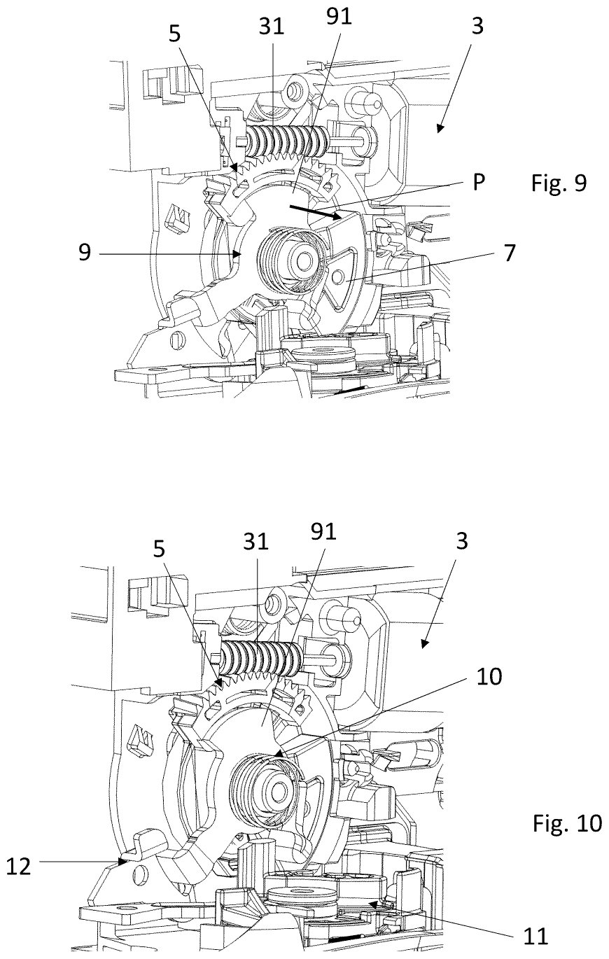

Another example may be when an electrical failure occurs during an electrical release. The central opening lever 9 and the electrical gear wheel 5 are blocked during the movement, in an intermediate position, between the rest and the opening positions, an example of which being illustrated FIG. 9.

When it pushes out (arrow P) the central opening lever 9 with the member 201 or 202 of the resetting device 200, the central opening lever 9 is displaced in the second axial position and disengaged from the electrical gear wheel 5.

As explained before, due to its disengagement from the electrical gear wheel 5, the central opening lever 9 is free to rotate and can be brought back, for instance by the spring 10, in its rest position, as illustrated in FIG. 10. On the contrary, the electrical gear wheel 5 does not move and stays in place in its current intermediate position.

When the central opening lever 9 is back in its rest position, the door latch 100 then becomes a purely mechanical latch, at least until the electrical failure is overcome (electrical power is back or the E-release function is working again). It is then possible to close the door safely after the reset. More precisely, the pawl can catch again the claw when the door is closed. If the door must be opened, the opening position can be led by the mechanical release mechanism, as described above. After reset, the door latch 100 can be operated in a backup mode, allowing manual closing or opening the door.

If the electrical failure has not been overcome after a mechanical release, the central opening lever 9 will, due to the spring 10 action, engage again with the electrical gear wheel 5. Indeed, the first leg 91 can engage the corresponding slot in the electrical gear wheel 5. The central opening lever 9 is thus blocked again.

### E-Release Reengagement

Besides, when the electrical failure is overcome, for instance when electrical power supply is available, if a safety procedure was initiated it may end, and the electrical gear wheel 5 goes back in its rest position. The electrical release motor 3 may bring the electrical gear wheel 5 back in its rest position.

If the central opening lever 9 was formerly disengaged from the electrical gear wheel 5, after a manual reset, it may then reengage with the electrical gear wheel 5, when the latter comes back in the rest position. Indeed, the electrical gear wheel 5 then faces the central opening lever 9 already in its rest position. Particularly, the first leg 91 in front of the corresponding slot of the electrical gear wheel 5, is pushed back inside the slot, as a result of the return force of the spring 10.

Hence, the E-release mechanism automatically reengages once the electrical failure is overcome, for instance the electrical power supply is back.

The vehicle door mechanism 1 as previously described provided with the resetting device 200 gives the possibility to reset the retention unit 2, specifically the pawl position to allow closing the door. Indeed, the resetting device 200 permits to disengage the central opening lever 9 from the electrical gear wheel 5, allowing the central opening lever 9 to come back to its rest position. Thus, the pawl can be placed in the rest position again to be able to catch again the claw. Thus, the door can be closed even in case of an electrical failure.

This resetting operation is possible from the door, whatever the door is open or closed. It can be done from a mechanical action of translating the member 201, 202 of the resetting device 200 inside the door latch 100, to push out the central opening lever 9 and reset the pawl. The decision of resetting can be voluntary done, for instance in case of emergency.

The present invention also refers to a vehicle door comprising the vehicle door latch 100, the resetting device 200, and possibly a casing 300 as previously described. The vehicle door may also comprise an inside handle and/or an outside handle for activating the mechanical release mechanism allowing closing and opening the door, for example after resetting, in a mechanical backup mode in case of an electrical failure.

1-16. (canceled)

17. A vehicle door latch for closing a vehicle door, comprising:
a retention unit configured to engage with a striker in a closed position and release the striker in an open position;
an electrical release motor;
an electrical gear wheel configured to be driven by said motor; and
an opening lever configured to pivot around a rotation axis between a rest position and an opening position, a movement of the opening lever to the opening position being configured to move the retention unit to the open position,
wherein the opening lever is configured to move along the rotation axis between:
a first axial position in which the opening lever engages the electrical gear wheel to allow the electrical gear wheel to drive the opening lever, and
a second axial position in which the opening lever disengages from the electrical gear wheel such that the opening lever is configured to move independently of the electrical gear wheel.

18. The vehicle door latch according to claim 17, wherein the opening lever comprises a pushing zone, and wherein the opening lever is configured to move to the second axial position when a resetting device configured to be manipulated from outside of the door latch reaches the pushing zone of the opening lever and displaces the opening lever.

19. The vehicle door latch according to claim 18, further comprising a member of the resetting device, mounted in a housing of said door latch, mobile in translation along a translation axis parallel to the rotation axis, and wherein said member comprises an end part protruding outside a face of the housing configured to be accessible from the outside of said door latch.

20. The vehicle door latch according to claim 19, wherein the face of the housing configured to be accessible from the outside of said door latch is configured to be placed in front of the striker and comprises a guide slot in which the striker is arranged.

21. The vehicle door latch according to claim 18, further comprising a housing with a face configured to be accessible from the outside of said door latch, said face being provided with an aperture facing said pushing zone, and through which a member of the resetting device external to said door latch is configured to be inserted.

22. The vehicle door latch according to claim 21, wherein the face of the housing configured to be accessible from the outside of said door latch is configured to be placed in front of the striker and comprises a guide slot in which the striker is arranged.

23. The vehicle door latch according to claim 17, wherein the door latch comprises a spring arranged to bring the opening lever back in the rest position and/or to bring the opening lever back in the first axial position.

24. The vehicle door latch according to claim 23, wherein:
in the first axial position, a leg of the opening lever is received in a corresponding slot defined in the electrical gear wheel,
in the second axial position, the leg of the opening lever is out of the corresponding slot defined in the electrical gear wheel, and
the spring is arranged to bring the opening lever back in the first axial position, when the slot defined in the electrical gear wheel faces the leg of the opening lever.

25. The vehicle door latch according to claim 17, further comprising a mechanical release mechanism comprising an inner release lever and/or an outer release lever configured to move independently of the electrical gear wheel and configured to move the retention unit from the closed position to the open position.

26. The vehicle door latch according to claim 25, wherein the inner release lever is configured to drive the opening lever from the rest position to the opening position to move the retention unit.

27. The vehicle door latch according to claim 17, wherein:
in case of an electrical failure, the electrical release motor is configured to block the electrical gear wheel in a position preventing the opening lever from returning to the rest position, and
when displaced in the second axial position, the opening lever disengaged from the electrical gear wheel, is configured to return to the rest position allowing the retention unit to return to the closed position.

28. The vehicle door latch according to claim 26, wherein:
in case of an electrical failure, the electrical release motor is configured to block the electrical gear wheel in a position preventing the opening lever from returning to the rest position,
when displaced in the second axial position, the opening lever disengaged from the electrical gear wheel, is configured to return to the rest position allowing the retention unit to return to the closed position, and
when the opening lever is in the rest position while disengaged from the electrical gear wheel, only the mechanical release mechanism is configured to move the retention unit from the closed position to the open position.

29. The vehicle door latch according to claim 24, further comprising:
a mechanical release mechanism comprising an inner release lever, wherein:
the inner release lever is configured to drive the opening lever from the rest position to the opening position to move the retention unit,
when the opening lever is in the rest position while disengaged from the electrical gear wheel, only the mechanical release mechanism is configured to move the retention unit from the closed position to the open position,
after the opening lever is moved to the opening position driven by the inner release lever, when the leg of the opening lever in the opening position faces the slot defined in the electrical gear wheel, the spring is configured to bring the opening lever back in the first axial position, such that the movement of the opening lever is blocked by the electrical gear wheel.

30. The vehicle door latch according to claim 24, wherein:
in case of an electrical failure, the electrical release motor is configured to block the electrical gear wheel in a position preventing the opening lever from returning to the rest position,
when displaced in the second axial position, the opening lever disengaged from the electrical gear wheel, is configured to return to the rest position allowing the retention unit to return to the closed position,
when the electrical failure is overcome, the electrical release motor is configured to bring the electrical gear wheel back in a rest position, and
when the slot defined in the electrical gear wheel faces the leg of the opening lever in the rest position, the spring is configured to bring the opening lever back in the first axial position.

31. A vehicle door mechanism, comprising:
the vehicle door latch according to claim 17; and
a resetting device configured to be manipulated from outside of the door latch,
wherein when manipulated, a member of the resetting device is configured to reach the opening lever and to displace the opening lever to the second axial position disengaged from the electrical gear wheel.

32. The vehicle door mechanism according to claim 31, wherein when manipulated, the member of the resetting device is configured to translate along a translation axis parallel to the rotation axis.

33. The vehicle door mechanism according to claim 32, wherein:
wherein the opening lever comprises a pushing zone, and wherein the opening lever is configured to move to the second axial position when a resetting device configured to be manipulated from the outside of the door latch reaches the pushing zone of the opening lever and displaces the opening lever,
the vehicle door latch further comprises a housing with a face configured to be accessible from the outside of said door latch, said face being provided with an aperture facing said pushing zone, and through which a member of the resetting device external to said door latch is configured to be inserted, and
the resetting device is external to said door latch and the member is configured to be inserted inside the door latch through the aperture in the face of the housing of said door latch, configured to be accessible from the outside of said door latch, the aperture facing the pushing zone of the opening lever.
